(19) United States
(12) Patent Application Publication
(10) Pub. No.: US 2005/0011079 A1
(43) Pub. Date: Jan. 20, 2005

(54) Template device and method of using same

(76) Inventors: Joseph G. Sikora JR., Englishtown, NJ (US); Raymond M. Mancison, Ridgefield Park, NJ (US)

Correspondence Address: REED SMITH LLP, 2500 ONE LIBERTY PLACE, 1650 MARKET STREET, PHILADELPHIA, PA, 19103, US

(21) Appl. No.: 10/793,601

(22) Filed: Mar. 4, 2004

Related U.S. Application Data
(60) Provisional application No. 60/451,792, filed on Mar. 5, 2003.

(51) Int. Cl. G01B 3/14

(52) U.S. Cl. 33/566; 33/528

(57) ABSTRACT

A template device and method of using same, the template device including: a substantially planar member defining a plurality of channels therein; wherein, the channels at least partially define a plurality of concentric shapes each corresponding to a known electrical box configuration, respectively. The method includes positioning a template defining a plurality of channels at least partially defining a plurality of concentric shapes each corresponding to a known electrical box configuration, respectively, at least substantially adjacent to walling material; selecting a subset of the channels corresponding to one of the defined shapes and the electrical box to be received; and, creating an opening in the walling material dependently upon the selected subset of channels.

### RELATED APPLICATION

This application claims priority of U.S. patent application Ser. No. 60/451,792, filed Mar. 5, 2003, lentitled TEMPLATE DEVICE AND METHOD OF USING SAME, the entire disclosure of which is hereby incorporated by reference as if being set forth in its entirety herein.

### FIELD OF INVENTION

The present invention relates generally to the installation of electrical boxes, such as those corresponding to electrical outlets and switches.

### BACKGROUND OF THE INVENTION

The installation of electrical boxes for electrical components is a task performed by experts and novices alike. Such installation may sometimes be performed through existing drywall, or other walling material, such as plaster by way of non-limiting example only. It is desirable to provide a device for facilitating the installation of such electrical boxes in a wall.

### SUMMARY OF THE INVENTION

A template device and method of using same, the template device includes: a substantially planar member defining a plurality of channels therein; wherein, the channels at least partially define a plurality of concentric shapes each corresponding to a known electrical box configuration, respectively. The method includes positioning a template device defining a plurality of channels at least partially defining a plurality of concentric shapes each corresponding to a known electrical box configuration, respectively, at least substantially adjacent to walling material; selecting a subset of the channels corresponding to one of the defined shapes and the electrical box to be received; and, creating an opening in the walling material dependently upon the selected subset of channels.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and

FIGS. 1-4 illustrate plan views of a template device according to an aspect of the present invention.

### DETAILED DESCRIPTION OF THE PREFERRING EMBODIMENTS

It is to be understood that the figures and descriptions of the present invention have been simplified to illustrate elements that are relevant for a clear understanding of the present invention, while eliminating, for purposes of clarity, many other elements found in typical templates and electrical box installation methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

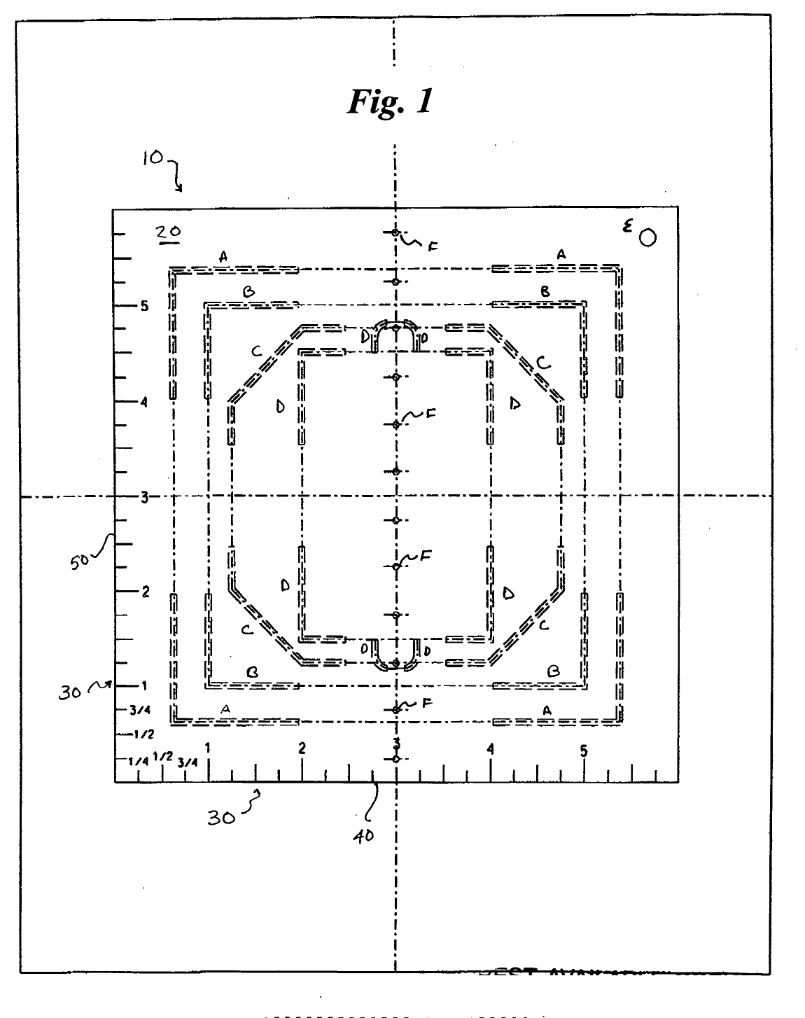

Referring now to FIG. 1 there is shown a plan-view of a template device 10 according to an aspect of the present invention. Template 10 may take the form of a substantially planar member 20 formed of any suitable conventional material, such as plastic or metal. According to an aspect of the present invention, member 20 may be transparent, translucent or opaque, by way of non-limiting example only. Member 20 may be flexible or substantially rigid, by way of non-limiting example only.

Template 10 may include a plurality of apertures. The apertures may take any suitable shape, and vary if desired. For example, in the illustrated non-limiting example, some apertures take the form of channels while others largely take the shape of circles. The apertures, may in part or whole, define a plurality of shapes A, B, C, D. For example, in the non-limiting illustrated case of FIG. 1, those apertures taking the form of channels define shapes A-D. The shapes may be defined in a concentric or aligned manner, such that the shapes are centered around a center line or right or left justified to one another, by way of non-limiting example only. Further, the apertures of template 10 defining one or more shapes may define a single shape, or be configured such that one or more common apertures may be used to define a plurality of shapes.

Each of the shapes A-D may correspond to an outline of a cut-out for a wall corresponding to a known electrical box configuration. For example, shape D is illustrated to take the form of a known shape corresponding to a two-outlet electrical box, while the illustrated shape A may correspond to a known shape corresponding to a 2×2 electrical outlet. Of course, the number and configuration of the plurality of shapes may vary depending upon design criteria, the shapes A-D of FIG. 1 being for purposes of non-limiting illustration only.

According to an aspect of the present invention, one or more of the plurality of apertures, designated E in FIG. 1, may be positioned and sized to be useful for carrying or storing template 10 when not in use.

According to an aspect of the present invention, one or more of the plurality of apertures, designated F in FIG. 1, may be positioned and sized to be useful in identifying a center line of shapes A-D-where the defined shapes are centered in at least one direction about the center line, for example.

According to an aspect of the present invention, template 10 may include dimensional markings 30. Dimensional markings 30 may take the form of length markings in English or metric units, by way of non-limiting example only. In the illustrated case of FIG. 1, markings 30 are included substantially adjacent to edges 40 and 50 of template 10.

According to an aspect of the present invention, one or more of the edges, such as edges 40 and 50 by way of non-limiting example only, may be beveled. Further, the apertures in template 10 may be beveled as well, although such is not necessary.

According to an aspect of the present invention, template 10 may include one or more leveling indicators being suitable for determining whether template 10 is positioned in a level manner. For example, template 10 may include one or more conventional leveling bubble containers found in conventional levels. Such leveling bubble containers may be positioned so as to be substantially parallel to edges 40 and 50, respectively, for example.

According to an aspect of the present invention, template 10 may be incorporated with a conventional stud-finding device that includes visual and/or audible indicators when positioned over a stud. For example, visual indicators that indicate the position of a stud under the template 10 in use may be included substantially adjacent to one or more edges, such as edges 40, 50 by way of non-limiting example only. Further, template 10 may be configured so as to be slideably engageable with a conventional stud finding device such that the edge of one or more defined shapes may be aligned with a sensed stud position in use. For example, and by way of non-limiting example only, the stud finding device may include a groove in which template 10 may slide and be substantially adjacent to a wall against which the stud finding device is being applied. Further, template 10 may include a slot into which a protrusion of the stud finder may be inserted, by way of non-limiting example only. This may be particularly useful where it is desirable to secure an electrical box to an existing stud behind a wall.

According to an aspect of the present invention, template 10 may be incorporated with a conventional sheet rock square. Further, template 10 may be configured so as to be slideably engageable with a conventional sheet rock square such that it may be slideably positioned on a piece of sheet rock in part by application the dry wall square to the piece of sheet rock. For example, and by way of non-limiting example only, the sheet rock square may include a groove in which template 10 may slide and be substantially adjacent to a piece of sheet rock against which the sheet rock square is being applied. Further, template 10 may include a slot into which a protrusion of the sheet rock square may be inserted, by way of non-limiting example only. This may be particularly useful where it is desirable to create an opening corresponding to an electrical box in a piece of sheet rock.

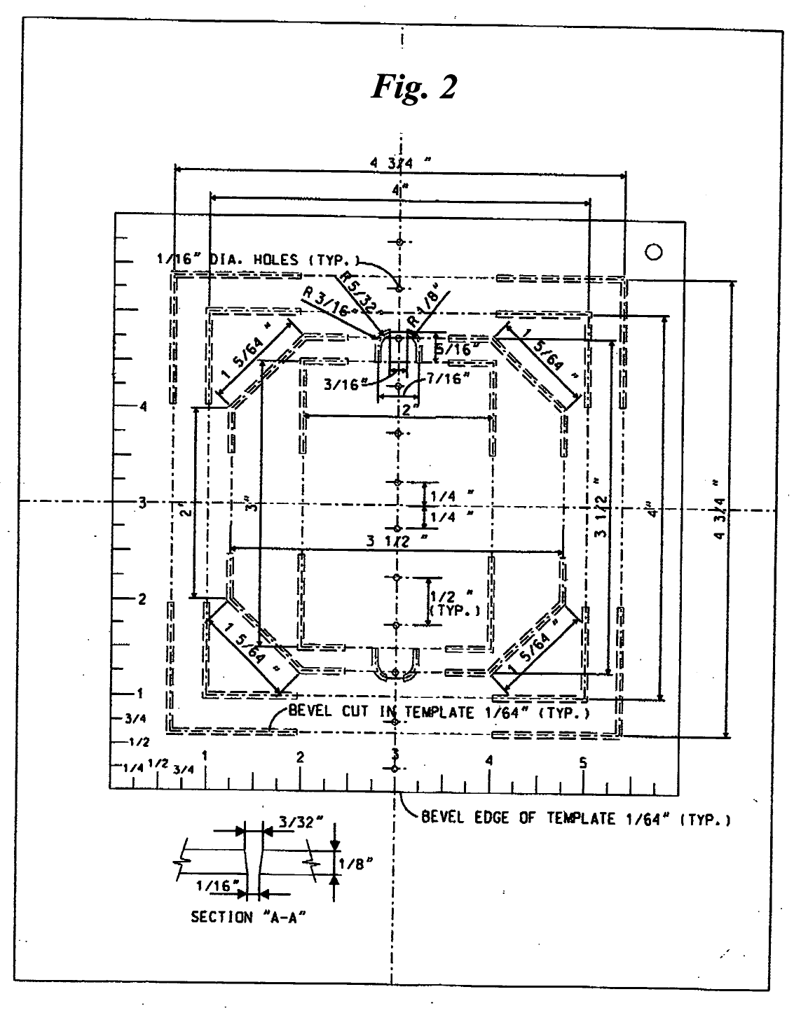

Referring now also to FIG. 2, there is shown another plan-view of a template 10. FIG. 2 further illustrates some non-limiting dimensions suitable for template 10 according to an aspect of the present invention.

According to an aspect of the present invention, in use, template 10 may be temporarily secured adjacent to, or substantially adjacent to, a wall in which an electrical box is to be installed such that a shape formed by the apertures of template 10 corresponding to the shape of the electrical box to be installed is substantially aligned to a desired installation location. Template 10 may be secured in any conventional manner, such as by pinning through one or more of the apertures, adhesively or by being held, by way of non-limiting example only.

The apertures forming the desired shape may then be used to mark the wall location by stenciling using a conventional marking device, such as a pencil or marker, by way of non-limiting example only. Alternatively, cuts in the wall may be achieved directly through the template 10 using a drill, and saw or razor blade, by way of non-limiting example only. After the wall has been marked, and/or cut, template 10 may be removed from the wall. If the wall has not yet been cut, the stenciled marking may be used to indicate a proper location for cutting to wall to facilitate installation of the corresponding electrical box.

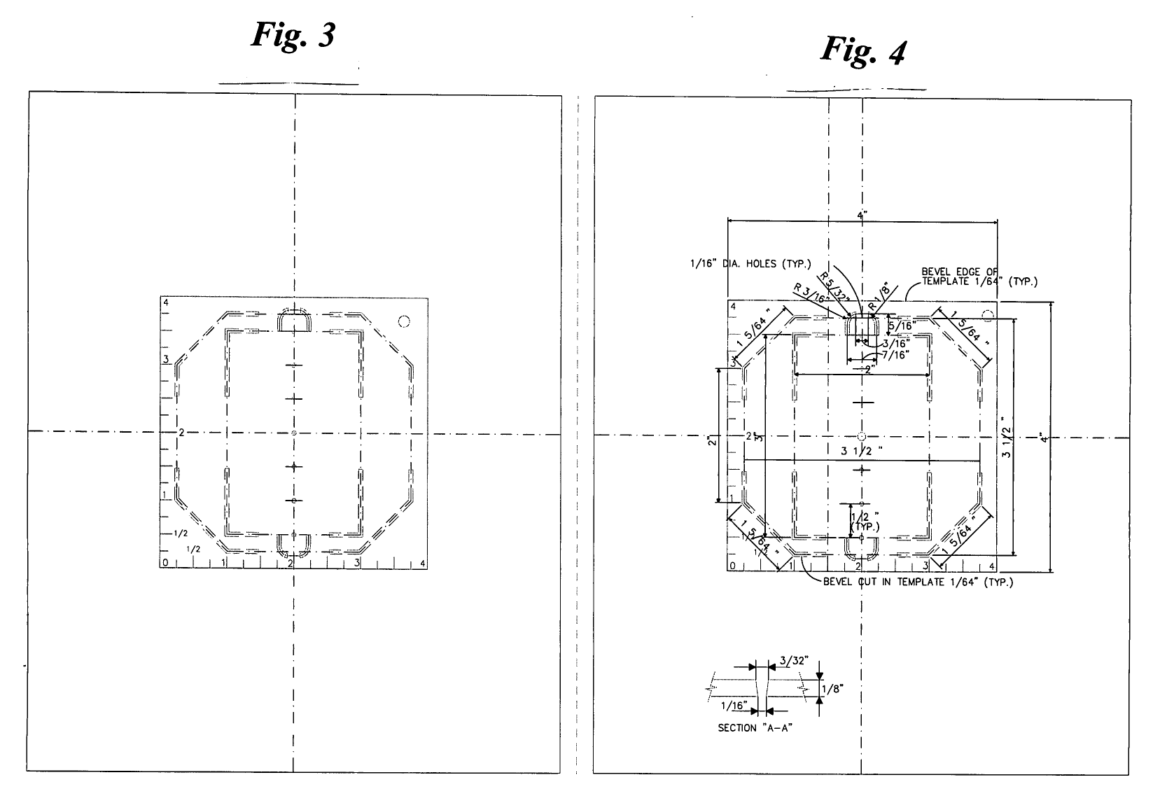

Referring now also to FIGS. 3 and 4, there are shown plan-views of a template according to an aspect of the present invention. FIG. 4 illustrates some non-limiting dimensions suitable for the template of FIG. 3.

A template device according to an aspect of the present invention may be formed in any suitable manner, such as conventional injection molding or stamping, by way of non-limiting example only.

It will be apparent to those skilled in the art that various modifications and variations may be made in the device and method of the present invention without departing from the spirit or scope of the invention. Thus, it is intended that the present invention cover the modification and variations of this invention.

1. A template device comprising: a substantially planar member defining a plurality of channels therein; wherein, said channels at least partially define a plurality of concentric shapes each corresponding to a known electrical box configuration, respectively.

2. The device of claim 1, wherein said substantially planar member comprises at least one of plastic and metal.

3. The device of claim 1, further comprising at least one leveling indicator coupled to said substantially planar member.

4. The device of claim 1, wherein at least a portion of said substantially planar member is substantially transparent.

5. The device of claim 1, wherein at least a portion of said substantially planar member is substantially translucent.

6. The device of claim 1, wherein at least a portion of said substantially planar member is substantially opaque.

7. The device of claim 1, wherein said a plurality of concentric shapes is 4 concentric shapes.

8. The device of claim 1, wherein said substantially planar member comprises outer beveled edges.

9. The device of claim 1, further comprising dimensional markings on said substantially planar member.

10. The device of claim 1, wherein at least one edge of at least one of said channels is beveled.

11. The device of claim 1, further comprising a stud sensor coupled to said substantially planar member.

12. The device of claim 1, wherein said stud sensor is slideably coupled to said substantially planar member.

13. The device of claim 1, further comprising a sheet rock square.

14. The device of claim 1, wherein at least one of said concentric shapes is selected from the group consisting of: a substantially 2 inch by 3 inch rectangle, a substantially 3½ inch octagon, and a substantially 4¾ inch square.

15. The device of claim 1, wherein said concentric shapes define at least a substantially 2 inch by 3 inch rectangle, a substantially 3½ inch octagon, and a substantially 4¾ inch square.

16. The device of claim 15, wherein said substantially planar member is approximately 6 inches by 6 inches in size, and further comprises:
dimensional markings substantially adjacent to at least two edges; and,
a plurality of apertures indicative of a center-line of said device.

17. A method for creating an opening in a piece of walling material being well suited for receiving an electrical box, said method comprising:
positioning a template defining a plurality of channels at least partially defining a plurality of concentric shapes each corresponding to a known electrical box configuration, respectively, at least substantially adjacent to said walling material;
selecting a subset of said channels corresponding to one of said defined shapes and said electrical box to be received; and,
creating an opening in said walling material dependently upon said selected subset of channels.

18. The method of claim 14, wherein said creating an opening comprises cutting said walling material dependently upon said selected subset of channels.

19. The method of claim 14, wherein said creating an opening comprises marking said walling material dependently upon said selected subset of channels.

20. The method of claim 19, wherein said creating an opening comprises cutting said walling material dependently upon said marking.
